(19) United States
(12) Patent Application Publication
(10) Pub. No.: US 2016/0378926 A1
(43) Pub. Date: Dec. 29, 2016

(54) SYSTEM AND METHOD FOR CORRELATING CHANGES OF BEST PRACTICE AND EBM TO OUTCOMES THROUGH EXPLICIT MAPPING AND DEPLOYMENT

(71) Applicant: PLEXINA INC., Calgary (CA)

(72) Inventors: WASYL BALUTA, Calgary (CA); SHAFQUAT MAHMUD, Calgary (CA)

(21) Appl. No.: 15/191,302

(22) Filed: Jun. 23, 2016

Related U.S. Application Data
(60) Provisional application No. 62/183,283, filed on Jun. 23, 2015.

(51) Int. Cl. G06F 19/00

(52) U.S. Cl. CPC G06F 19/325; G06F 19/345

(57) ABSTRACT

A method and system is provided for the creation and real-time deployment of clinical decision support assets into clinical information systems and for assessing the impact of the changes over, for example, cost and clinical performance measures of patient care. The present invention can provide real-time clinical effectiveness correlation to practice changes.

### FIELD OF THE INVENTION

The invention disclosed herein relates to a particular system and method that allows for improved creation and real-time deployment of clinical decision support assets into dynamic clinical information systems (CIS) and for assessing the impact of changes to CDS Assets over cost and clinical performance measures of patient care, with automated systems to provide evidence-based CDS Asset adjustments for improved EBM and care.

### BACKGROUND OF THE INVENTION

Population health and clinical effectiveness researchers traditionally design criteria associated with CDS Assets and similar guidance for patient care pathways, processes, therapies and interventions to arrive at CDS Asset candidacy and evaluation criteria that define the scope of patients and patient cases that should be considered for research, when approaching EBM solutions to improve CDS Assets. A Glossary of terms and acronyms is provided at the end of the description section. These research criteria are criteria that may be needed to be evaluated on the candidate CDS Asset cases. In the prior art, this was a large manual effort where a clinical researcher works with database administrators to attempt to write and run many ad hoc queries against the CIS data, for instance, to determine the candidate patient records which involved the CDS Asset, and then further ad hoc queries to provide research results of the measures against candidate patients records, and their use of the CDS Assets. Such a research project can be typically time consuming and costly. Furthermore, the research can be fragile semantically. The researcher must identify all combinations of various observations and elements that may apply, and manually construct queries that expand these combinations. In medicine, the science of best practices changes, and thus reporting needs and available data warehouse structures may also change frequently. Keeping a normalized data repository yields more stability when changes occur, but requires more work to get specific information for reporting. A highly normalized system can be extremely difficult to maintain.

EBM-focused Clinical Decision Support (“CDS”) can potentially improve cost and effectiveness of clinical care. However, measuring and quantifying that potential may involve focused study with a disconnected implementation effort and a separate assessment effort. Implementation and assessment in the prior art uses different processes and tools without explicit data linkage between practice changes and the actual outcomes observed.

Previous systems and methods may result in disconnect points between clinical knowledge and actual concepts deployed in the Clinical Information Systems which can result in a necessarily complex and error-prone manual resolution step by clinically skilled individuals during design, deployment, and assessment.

Those skilled in the art will also recognize that in order to deal with clinical decisions relative to systems as complex as the systems of the human body, medical science and evidence for care best-practices for diagnosis and treatment of various disorders change continuously with a very high (and increasing) number of interdependencies. The number of CDS Assets in a CDS knowledge base can number in the thousands, with asset-to-asset and patient co-morbidity inter-relationships adding orders of magnitude more complexity. As such, a CDS Asset improvement system based on EBM requires dynamic capabilities of detecting impacts of changes to a single CDS Asset on all interdependent CDS Assets. Furthermore, downstream assessment may be impacted and need to dynamically adapt to infer the sought-for EBM improvements to clinical assessment measures. [E.g. Thrombolysis is the treatment of blood clots, which can be a risk in many other standard treatment protocols, including for trauma, post-surgery, strokes, and with many other disorders. Making a change to the CDS assets for best-practice Thrombolysis creates a downstream impact on all other treatments that are dependent.] Such a CDS improvement system must necessarily discover and maintain interdependencies to inform CDS Asset designers of impact, and also support necessary assessment measure dependency for meaningful research for evaluation and inference.

It would consequently be desirable to provide a means for allowing the creation and automated real-time deployment of dynamic EBM-improvements to Clinical Decision Support Assets in Clinical Information Systems, and for assessing the impact of changes to CDS Assets or practice to cost and clinical performance measures of patient care.

Applicant notes that the prior art relevant to this invention includes the application of natural language programming and set theory algebra to data analytics in relation to CIS and other medical records described in U.S. Pat. No. 8,346,698, U.S. Pat. No. 8,666,785, application number PCT/CA2014/051152 and U.S. Application No. 61/368,526, over each of which this is an improvement in at least particular areas.

### SUMMARY OF THE INVENTION

The invention disclosed herein is generally directed to systems and methods involving real-time clinical effectiveness correlation to practice changes.

As clinical knowledge changes, clinical researchers may use this invention to access a real-time capability to infer the clinical semantics as designed with the information as recorded on the patient record, and then leverage semantics in the assessment of change on patient care, for dynamic adjustment to CDS Assets based on EBM research using real, dynamic CIS based evidence.

By combining directly relatable outcomes data with the knowledge base of CDS Assets (intended clinical best practices) with the change and release history of the Assets with pattern matching engines and CDS development change history, the methods or systems of the present invention can identify explicit changes in clinical practice that correlate to substantial impact on cost or clinical effectiveness (negatively or positively). Changes which improved or hurt outcomes may be found and explained, without needing clinicians who are trained to know what to look for, on a (relatively) automated basis by the system of this invention.

To those skilled in the art, the clinical knowledge and best-practices for care take on many forms of CDS Assets, including order sets, clinical documentation templates, care pathways, measures, criteria, and so forth. Related to the complexity of the human body and interdependencies of its systems and functions, the interdependencies of CDS Assets are as vast, making it necessary to have a machine-assisted dynamic capability for contextualization and interdependency discovery in order to have EBM on a meaningful and useful time-frame.

In one aspect, a clinical concept of a CDS Asset may be directly executable by containing encoded structured semantics and the CDS Asset may then be directly used at design, deployment, and assessment stages, enabling a real-time effectiveness impact reporting capability that can be directly tied to the deployed Asset concepts, their originating design, and the explicit semantics.

In accordance with another embodiment, the present invention can comprise a system for allowing the creation and real-time deployment of Clinical Decision Support Assets into Clinical Information Systems and for assessing the impact of the changes over cost and clinical performance measures of patient care, including one or more of:
A user interface and automation for converting unstructured and unstandardized clinical knowledge within a CDS system or a CIS into structured, semantically encoded, directly deployable CDS Assets in a health information technology system and means for enabling the effectiveness measurement of the use of the deployed CDS Assets by representing semantically flexible measures, a semantic comparator, observational documentation, service utilization, cost data, and a semantic contextualizer.
The semantic contextualizer identifies all CDS and semantic concepts relevant to an input CDS Asset by analyzing explicit links, or inferred relationships from exact or similar semantics of CDS concepts explicitly identified in deployable CDS Assets such as care pathways, care plans, assessments, order sets, rules, measures, and other CDS Assets or sub-Assets.
An automated translator can be provided for converting clinical knowledge into a standardized structure and standardized terminology for forming a CDS Asset (which can take the form of order sets, orders, assessments, structured documentation templates, observations, rules, care pathways, care plans, effectiveness measures profile, and other such artifacts).
In accordance with the present invention, an effectiveness measure may be a performance indicator that can relate directly to the use of observations and orders in the CDS Assets.
A user interface for managing the deployment of a CDS Asset into discrete change and release bundles and to automate deployment, which can be scheduled to be performed or executed at a specific time and date.
A patient record analytic query component that analyzes the semantic context of deployable CDS Assets and the CDS assessment measure assets deployment configurations to dynamically derive a patient record analytic query for collecting measures of cost and clinical effectiveness for arbitrary time periods of actual use of the CDS Asset of relevance on patients. The dynamically assembled context of related deployable CDS Assets identifies the scope of semantics of the CDS assessment measure and therefore the scope of the necessary patient data from a relevant CIS required to query.
Means for correlating the time period of collected effectiveness measures and results with actual CDS Asset release dates and times of CIS entries.
Means for identifying the measurable impact of individual changes to CDS Assets, order sets and assessment components including orders or observations that can apply to the clinical CDS Asset and dynamically assembling assessment data queries from semantic inference of CDS associations and CDS Asset configurations.
Means for identifying and presenting major impacts on all relevant CDS Assets deployed within the affected semantic context.
A user interface that can define new effectiveness measures and measure set profiles and form an effectiveness study. The effectiveness measure and measure sets are semantically encoded constructs.
A user interface allowing for the review and commenting on of results by clinical researchers.
A user interface allowing for a change request by clinical researchers, or approvals of CDS Asset policy managers.

In accordance with another embodiment, the present invention can comprise a method for allowing the creation and real-time deployment of Clinical Decision Support Assets into Clinical Information Systems and for assessing the impact of the changes over cost and clinical performance measures of patient care, including one or more of:
Converting unstructured and unstandardized clinical knowledge into structured, semantically encoded, directly deployable CDS Assets in a health information technology system or CIS.
Enabling the effectiveness measurement of the use of deployed CDS Assets by representing semantically flexible measures, a semantic comparator, observational documentation, service utilization, cost data, and semantic contextualizer.
The semantic contextualizer dynamically identifies all deployable CDS Assets and the semantic concepts relevant to an input CDS by analyzing explicit links, or inferred relationships from exact or similar semantics of concepts in CDS assessment measures related explicitly to deployable CDS Assets such as care pathways, care plans, assessments, order sets, rules, measures, and other CDS.
Managing the deployment of CDS Assets into discrete change and release bundles, scheduled to be performed or executed at a specific time and date.
Collecting measures of cost and clinical effectiveness for arbitrary time periods of actual use on patients from the CIS relevant to a deployed CDS Asset. The dynamically assembled deployable CDS context identifies the scope of semantics of the CDS assessment measures and therefore the scope of the necessary patient data in the CIS required to query to evaluate the measure.
Identifying the measurable impact of individual changes to CDS Assets such as order sets, and assessment components including orders or observations that can apply to the clinical application of a CDS Asset. The impact is identified by measuring utilization and outcome prior to deployment of a CDS Asset and then over an arbitrary period of time after deployment of a CDS Asset once modified.
Identifying and presenting major impacts by dynamically evaluating all associated CDS Asset changes modified in the time period, and ranking the correlated change in outcome measures, costs, or other performance indicators.
Defining new effectiveness measure profiles and forming further effectiveness study or studies. The effectiveness analyzer retrieves the semantics of deployable CDS Assets relevant to the CDS assessment measures. Leveraging the deployable CDS Assets' native data configurations, the effectiveness analyzer dynamically constructs a complete query to retrieve actual patient data, translates the native data to the semantic equivalent data, evaluates the semantic measure expression to infer a result for the measure, and reports the inferred results.
Providing means for allowing review and discussion of results by clinical researchers.
Providing means for allowing a change request by clinical researchers.

### BRIEF DESCRIPTION OF THE DRAWINGS

The subject matter which is regarded as the invention is particularly pointed out and distinctly claimed in the concluding portion of the specification. The invention, however, may best be understood by reference to the following detailed description of embodiments and accompanying drawings in which:

FIG. 1 is a block-diagram disclosing functions and steps of a method and system of the present invention.

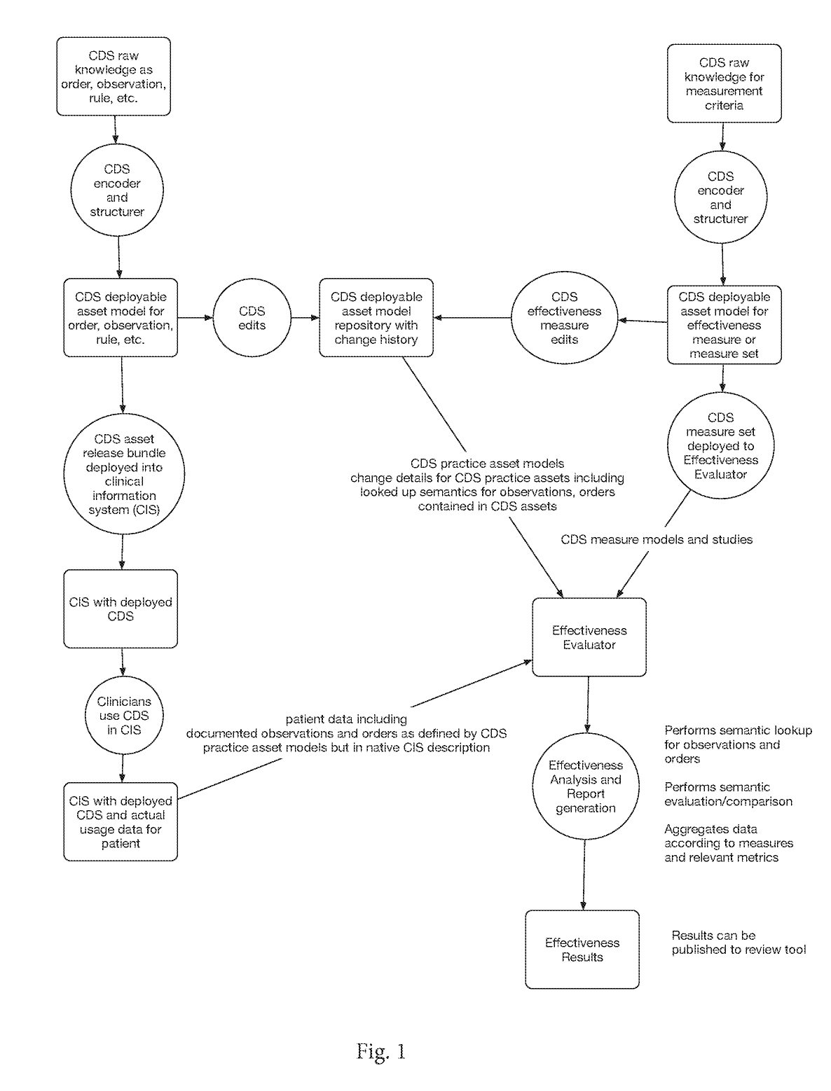

### DETAILED DESCRIPTION OF THE PREFERRED EMBODIMENTS

An automated method for creation and real-time deployment of Clinical Decision Support (CDS) Assets into dynamic a Clinical Information System (CIS) and for assessing the impact of changes to certain of the CDS Assets in terms of cost and clinical performance measures by reference to information in the CIS, to provide evidence-based CDS Asset adjustments for improved Evidence Based Medicine (EBM) and care, which may also be dynamic, comprising:
a. building a deployable CDS Asset (which CDS Asset may be comprised of an order set, clinical documentation template, rule, assessment model, care pathway, care plan or similar documentation or intervention protocol);
   i. importing basic natural concepts of a CDS Asset including orders, observations, or qualifying concepts from a common electronic format, including word, text, spreadsheet, XML, or some data extract from a CIS
   ii. translating the CDS Asset and the basic CDS natural concepts into native coded concepts (which concepts may comprise observations, orders, and qualifying dictionaries, etc.) of the CIS and specifications of their native deployable structure
   iii. translating the same native coded concepts to standard semantic ontology concepts (which ontology concepts may be from industry standard ontologies such as SNOMED CT, RxNORM, RadLex, LOINC, CPT, UMLS, or similar semantic ontologies or terminology sets)
   iv. structuring the translated CDS Asset and concepts into one or more appropriate CDS Asset model schemas such as order sets, clinical documentation templates, assessment models, rules, measures, and other clinical support tools with observations and interventions
   v. presenting the CDS Assets for formal or informal review which may include:
      presenting design in a simulation of clinical workflow;
      presenting a potentially realistic CIS simulation;
      manual validation and refinement of concepts;
      approval of the CDS Asset for deployment
   vi. assembling and scheduling a release bundle of proposed/improved

CDS Assets
vii. deploying the improved/proposed CDS Asset into the CIS, with or without version control or other standard operational protocols to:
   establish a point-in-time record of deployment of the CDS Assets and components into the target CIS;
   capture a record of the review feedback and approval;
b. building (at least one) performance measure for clinical effectiveness assessment including determining the presence or lack of presence in the patient record of documented symptoms, conditions, history, interventions ordered and performed, qualifying intervention details specific to the patient, and any other data that may be associated with a patient in a CIS, including the steps of:
   i. translating the natural measure concepts to standard terminologies and/or semantic ontology concepts
   ii. identifying the scope of clinical context of the deployable CDS Assets that are involved in the measurement via semantic similarity, directly linked CDS Assets, and overarching CDS Asset types (such as care pathways, or care plans, or other CDS type that coordinate aspects of care and other CDS Assets in support of those aspects of care)
   iii. looking up a native deployment configuration of the CIS Asset (data schema specification) to define how to retrieve patient data relevant to the CDS Asset being measured
   iv. dynamically assembling a native query to retrieve the clinical context of the patient record in a CIS relevant to the measure;
      Alternatively, all the patient records in a CIS can be semantically indexed to accelerate future retrieval semantically indexing the CIS's native data for each deployable CDS Asset being measured which is used or relevant to be used for the patient conditions handled by the CDS Asset in the CIS AND apply direct semantic query to the CIS's native patient data.
   v. from the retrieved semantic data of the clinical context relevant to the measure, concluding whether the measure was satisfied, or not satisfied, i.e. present or not present, or evaluate a measure expression to infer a result value
   vi. several measures can be assembled into profiles to measure segments of, one or more CDS Assets to achieve multiple levels of evaluation based upon elements of the CIS' patient data, including:
      L1 is the patient a candidate for this effectiveness assessment—right patient conditions, disorders, criteria, age, gender, etc.
      L2. was the appropriate care plan/treatment used for the disorder and indications
      L3. was the appropriate care plan/treatment applied by the care team, were all the orders delivered
      L4. if (one or more of L1-L3 is) yes, then is the CDS Asset's intervention/treatment working or not (i.e. whether the utilization change, cost change, outcome change is as expected, positive or negative)
      L5. what changes to the CDS Asset being measured yielded the greatest impact and in what measured dimension/profile segment?
c. evaluating the measures by:
   i. using the CDS Asset's semantic context and deployment configuration specifications, to assemble a clinical context for querying, and retrieving data that is in scope of the measure profile(s)
   ii. aggregating measured inferred result data into one or more useful reports showing baseline CDS Asset performance
   iii. if measuring a CDS Asset that has been updated and redeployed, then calculating and reporting a comparison of CDS Asset performance before the change, vs the CDS Asset performance after the change, identifying the impact
   iv. identifying CDS Asset changes with the greatest impact (report with ranking of greatest change)
d. adjusting the CDS Asset chosen according to the system's findings by:
   i. making design changes to the CDS Asset and/or measures chosen (i.e. repeat step a)
   ii. redeploy the redesigned CDS Asset
   iii. reevaluate the CDS Asset (i.e. repeat steps b, and c)
   iv. reiterate as required
      Similarly, the system and method may be dynamic by being automated, by providing computing devices which are operably interconnected to a CIS with conventional other I/O and storage, processing and memory means, programmed and configured with software to have various operational means to provide each functional step detailed in the description above, and throughout this detailed description (and the claims).

The present invention generally relates to systems, as well as methods used for the creation and real-time deployment of Clinical Decision Support Assets into Clinical Information Systems and for the assessment of the impact of the changes over cost and clinical performance measures of patient care. When describing the present invention, any term or expression not expressly defined herein shall have its commonly accepted definition understood by those skilled in the art. To the extent that the following description is of a specific embodiment or a particular use of the invention, it is intended to be illustrative only, and not limiting of the invention, which should be given the broadest interpretation consistent with the description as a whole and with the claims.

In accordance with another embodiment, the present invention may directly link outcomes data from a CIS to a knowledge base of CDS Assets, including CDS Asset change and release history. With pattern matching techniques and change history, the present invention can identify explicit changes in CDS Assets that netted substantial impact on cost and/or clinical effectiveness as recorded in a CIS. In general, the present invention may identify and explain the clinical practice changes that worked or didn't work, and the measurable impact that they had, thereby directly associating practice standards and CDS Asset changes with recognizable value.

The present invention may also form a mechanical, semantically accurate, accountable means for potentially dynamically relating observational evidence captured in patient records by clinical/health information systems (CIS) to intended best practices clinical experts have designed, approved and deployed (CDS Assets), and also measure their impact.

In accordance with one embodiment, the present invention can comprise a system or method that can encompass one or more of:
A user interface and automation that can convert unstructured and unstandardized clinical knowledge about how to assess, diagnose and treat patients with various disorders into structured, semantically encoded, directly deployable assets in a health information technology system. The present invention may also enable the effectiveness measurement of the use of the deployed CDS Assets by representing semantically flexible measures, a semantic comparator, observational documentation, service utilization, cost data, semantic contextualizer, etc. The semantic contextualizer identifies all related deployable CDS Assets relevant to the semantics of the CDS assessment measure to form a scope of context for native querying.
Automation, such as an automated translator, that may be used for converting the clinical knowledge into a standardized structure and standardized terminology form to form a clinical decision support asset model.

The CDS Assets may take the form of order sets, orders, assessments, structured documentation templates, observations, rules, care pathways, care plans, effectiveness measures profile, and other such artifacts. A CDS Asset model may directly be mapped to deployable records in one or more Clinical Information Systems. CDS Asset concepts can be mapped to one or more native objects of one or more health information technology systems, along with one or more semantic concepts (for example, drawn from an ontology (such UMLS, SNOMED CT, or etc.). Together these various descriptions of the same CDS Asset concept can form a deployable component of a clinical context into one or more Clinical Information System.

In accordance with the present invention, an effectiveness measure can be a performance indicator that directly relates to the use of observations and orders in the CDS Assets. The performance measure can itself be a CDS Asset with one or more lay descriptions for various presentations, a set of semantic concepts from an ontology, and zero or more deployable records from a Clinical Information System.

A user interface can be included, which may be used for managing the deployment of CDS Assets into discrete change and release bundles and automated deployment, that can be scheduled to be performed or executed at a specific time and date.

A patient record analytic query component is provided, which may be used for collecting results of use of the CDS Asset components related to effectiveness measures, including data from the patient record in a CIS regarding the use of services (which may be linked to the CDS Asset via the CDS Asset model built in design), documented observations or problems (which may be linked to the CDS Asset via the CDS Asset model built in the design), costs of services, or over relevant time periods to actual use on patients. Further aspects can also include: correlating a relevant time period of the collected effectiveness measure results with actual CDS Asset or bundle release dates and times; looking up semantic codes for context of care, services and observations from the CDS Asset model; links in changes deployed by the CDS Asset release bundle including date of release, CDS Assets released, the full CDS Asset, and differences from a prior deployed CDS Asset and its component orders/services, observations, confirmed diagnoses, discharge outcome, and so on.

An analytic effectiveness evaluation component is provided, which can include: an input, the semantic codes and evaluation directives of one or more effectiveness measure CDS Assets; an input, the collection of patient record data in a CIS with the orders and observations and other relevant records data, together with the semantic codes looked up from the CDS Asset models used during design; a semantic comparator that can match sets of codes of the effectiveness measures to the set of semantic codes of the CIS patient record, where a directive may indicate whether the matching requires any or all codes to be matched and may also indicate if the match needs to be specific (at this semantic level or more specific), or general (at this semantic level and more generic), or exact (at exactly this semantic level); means for producing one or more reports that can combine changes in slope on trends of individual metrics such as utilization, cost, outcome, and CDS Asset changes released in that relevant measured and compared timeframe made to orders, order sets, observations, confirmed diagnoses, discharge outcome and other assessable components, and so on, that can apply to the clinical CDS Asset.

An analytic effectiveness evaluation component is also provided, which can scan all changes released to the CDS Assets, and collect patient data from a CIS for changes in slopes of metric trends over arbitrary periods to identify and present major trend changes and order change-related results by greatest trend change or volume of affected patients.

A user interface can be provided to define new effectiveness measures and collections of measures to manually or with automated assistance of the system form an effectiveness study. The effectiveness measure can be a semantically encoded construct that may include a user interface to define the time period of analysis of the effectiveness study, schedule a repeat of the study to be run over a different time period, and compare results of one time period to another and overlaying the metrics

The present invention also may comprise further means, such as a user interface, for posting an effectiveness study, potentially anonymized to a web based review tool, where users can review and provide feedback on the results.

In a further embodiment, the present invention may also provide a user interface for allowing a change request by a clinical researcher to modify the operation of the system's effectiveness survey.

In the preceding description, for purposes of explanation, numerous details are set forth in order to provide a thorough understanding of the embodiments of the invention. However, it will be apparent to one skilled in the art that these specific details are not required in order to practice the invention.

The above-described embodiments of the invention are intended to be examples only. Alterations, modifications and variations can be effected to the particular embodiments by those of skill in the art without departing from the scope of the invention.

### GLOSSARY OF TERMS

“CDS”—Clinical Decision Support
“EBM”—Evidence Based Medicine
“CDS”—Clinical Decision Support
“CIS”—Clinical Information Systems typically large-scale dynamic patient-data and clinical management systems
CDS Asset—order sets, orders, assessments, structured documentation templates, observations, rules, care pathways, care plans, effectiveness measures profile, and other such artifacts

What is claimed is:

1. A system for the creation and real-time deployment of a Clinical Decision Support Asset into Clinical Information Systems and for assessing the impact of the changes over cost and clinical performance measures of patient care, including one or more of:
a. a user interface and automation for converting unstructured and unstandardized clinical knowledge within a CDS system or a CIS into structured, semantically encoded, directly deployable CDS Assets in a health information technology system
b. means for enabling the effectiveness measurement of the use of the deployed CDS Asset by representing semantically flexible measures, including one or more of a semantic comparator, observational documentation, service utilization, cost data, and semantic contextualizer
c. Where semantic contextualizer identifies all CDS and semantic concepts relevant to an input CDS Asset by analyzing explicit links, or inferred relationships from exact or similar semantics of CDS concepts explicitly identified in deployable CDS Assets such as care pathways, care plans, assessments, order sets, rules, measures, and other CDS Assets or sub-Assets
d. An automated translator for converting clinical knowledge into a standardized structure and standardized terminology for forming a CDS Asset (which can take the form of order sets, orders, assessments, structured documentation templates, observations, rules, care pathways, care plans, effectiveness measures profile, and other such artifacts); an effectiveness measure may be a performance indicator that can relate directly to the use of observations and orders in the CDS Assets
e. A user interface for managing the deployment of a CDS Asset into discrete change and release bundles and to automate deployment, which can be scheduled to be performed or executed at a specific time and date
f. A patient record analytic query component that analyzes the semantic context of deployable CDS Assets and the CDS assessment measure assets deployment configurations to dynamically derive a patient record analytic query for collecting measures of cost and clinical effectiveness for arbitrary time periods of actual use of the CDS Asset of relevance on patients; the dynamically derived context of related deployable CDS Assets identifies the scope of semantics of the CDS assessment measure and therefore the scope of the necessary patient data from a relevant CIS required to query
g. Means for correlating the time period of collected effectiveness measures and results with actual CDS Asset release dates and times of CIS entries
h. Means for identifying the measurable impact of individual changes to CDS Assets, order sets and assessment components including orders or observations that can apply to the clinical CDS Asset and dynamically assembling assessment data queries from semantic inference of CDS associations and CDS Asset configurations
i. Means for identifying and presenting major impacts on all relevant CDS Assets deployed within the affected semantic context
j. A user interface that can define new effectiveness measures and measure set profiles and form an effectiveness study; the effectiveness measure and measure sets are semantically encoded constructs
k. A user interface allowing for the review and commenting on of results by clinical researchers
l. A user interface allowing for a change request by clinical researchers, or approvals of CDS Asset policy managers

2. A method for the creation and real-time deployment of Clinical Decision Support Assets into Clinical Information Systems and for assessing the impact of the changes over cost and clinical performance measures of patient care, including one or more of:
a. Converting unstructured and unstandardized clinical knowledge into structured, semantically encoded, directly deployable CDS Assets in a health information technology system
b. Enabling the effectiveness measurement of the use of the deployed CDS Assets by representing semantically flexible measures, comprising one or more of a semantic comparator, observational documentation, service utilization, cost data, and semantic contextualizer
c. Where the semantic contextualizer dynamically identifies all deployable CDS Assets and the semantic concepts relevant to an input CDS by analyzing explicit links, or inferred relationships from exact or similar semantics of concepts in CDS assessment measures related explicitly to deployable CDS Assets such as care pathways, care plans, assessments, order sets, rules, measures, and other CDS
d. Managing the deployment of CDS Assets into discrete change and release bundles, scheduled to be performed or executed at a specific time and date
e. Collecting measures of cost and clinical effectiveness for arbitrary time periods of actual use on patients from the CIS relevant to a deployed CDS Asset, where the dynamically assembled deployable CDS context identifies the scope of semantics of the CDS assessment measures and therefore the scope of the necessary patient data in the CIS required to query to evaluate the measure
f. Identifying the measurable impact of individual changes to CDS Assets such as order sets, and assessment components including orders or observations that can apply to the clinical application of a CDS Asset, where impact is identified by measuring utilization and outcome prior to deployment of a CDS Asset and then over an arbitrary period of time after deployment of a CDS Asset once modified
g. Identifying and presenting major impacts by dynamically evaluating all associated CDS Asset changes modified in the time period, and ranking the correlated change in outcome measures, costs, or other performance indicators
h. Defining new effectiveness measure profiles and forming further effectiveness study or studies where the effectiveness analyzer retrieves the semantics of deployable CDS Assets relevant to the CDS assessment measures, and leveraging the deployable CDS Assets' native data configurations, the effectiveness analyzer dynamically constructs a complete query to retrieve actual patient data, translates the native data to the semantic equivalent data, evaluates the semantic measure expression to infer a result for the measure, and reports the inferred results
i. Defining new effectiveness measures and collections of measures to form an effectiveness study
j. Providing means for allowing review and discussion of the results; and
k. Providing means for allowing a change request.

3. An automated method for creation and real-time deployment of Clinical Decision Support (CDS) Assets into dynamic a clinical information system (CIS) and for assessing the impact of changes to certain of the CDS Assets in terms of cost and clinical performance measures by reference to information in the CIS, to provide evidence-based CDS Asset adjustments for improved Evidence Based Medicine (EBM) and care, comprising:
a. building a deployable CDS asset (which CDS Asset may be comprised of an order set, clinical documentation template, rule, assessment model, care pathway, care plan or similar documentation or intervention protocol);
i. importing basic natural concepts of a CDS Asset including orders, observations, or qualifying concepts from a common electronic format, including word, text, spreadsheet, XML, or data extract from a CIS
ii. translating the CDS Asset and the basic CDS natural concepts into native coded concepts (which concepts may comprise observations, orders, and qualifying dictionaries, etc.) of the CIS and specifications of their native deployable structure
iii. translating the same native coded concepts to standard semantic ontology concepts (which ontology concepts may be from SNOMED CT, RxNORM, RadLex, LOINC, CPT, UMLS or similar standard semantic ontologies)
iv. structuring the translated CDS asset and concepts into one or more appropriate CDS Asset model schemas such as order sets, clinical documentation templates, assessment models, rules, measures, and other clinical support tools with observations and interventions
v. presenting the CDS Assets for formal or informal review which may include one or more of:
i. presenting design in a simulation of clinical workflow;
ii. presenting a potentially realistic CIS simulation;
iii. manual validation and refinement of concepts; or
iv. approval of the CDS Asset for deployment
vi. assembling and scheduling a release bundle of proposed/improved CDS Assets
vii. deploying the improved/proposed CDS Asset into the CIS, with or without version control or other standard operational protocols to:
i. establish a point-in-time record of deployment of the CDS Assets and components into target CIS;
ii. capture a record of the CDS Asset version being reviewed, review feedback, and approval;
b. building (at least one) performance measure for clinical effectiveness assessment including determining the presence or lack of presence in the patient record of documented symptoms, conditions, history, interventions ordered and performed, qualifying intervention details specific to the patient, and any other data that may be associated with a patient in a CIS, including the steps of:
i. translating the natural measure concepts to standard terminologies and/or semantic ontology concepts
ii. identifying the scope of clinical context of the deployable CDS Assets that are involved in the measurement via semantic similarity, directly linked CDS Assets, and overarching CDS Asset types which may include care pathways, or care plans, or other CDS type that coordinate aspects of care and other CDS Assets in support of those aspects of care
iii. looking up a native deployment configuration of the CIS Asset data schema specification to define how to retrieve patient data relevant to the CDS Asset being measured
iv. dynamically assembling a native query to retrieve the clinical context of the patient record relevant to the measure;
v. from the retrieved semantic data of the clinical context relevant to the measure, concluding whether the measure was satisfied, or not satisfied, i.e. present or not present, or evaluating and recording a measure expression to infer a result value
vi. several measures can be assembled into profiles to measure segments of one or more CDS Assets to achieve multiple levels of evaluation based upon elements of the CIS′ patient data, including:
L1. is the patient a candidate for this effectiveness assessment—right patient conditions, disorders, criteria, age, gender, etc.
L2. was the appropriate care plan/treatment used for the disorder and indications
L3. was the appropriate care plan/treatment applied by the care team, were all the orders delivered
L4. if (one or more of L1-L3 is) yes, then is the CDS Asset's intervention/treatment working or not (i.e. is the utilization change, cost change, outcome change as expected, positive or negative?)
L5. what changes to the CDS Asset being measured yielded the greatest impact and in what measured dimension/profile segment?
c. evaluating the measures by:
i. using the CDS Asset's semantic context and deployment configuration specification, to assemble a clinical context for querying, and retrieving data that is in scope of the measurement profile
ii. aggregating measure inferred result data into one or more useful reports showing baseline CDS Asset performance iii. if measuring a modified CDS Asset that has been updated and deployed, then calculating and reporting on comparison of CDS Asset performance before CDS Asset change deployed vs after CDS Asset change deployed to identify an impact of the change
iv. identifying CDS Asset changes with the greatest impact, by making a report ranking greatest change
d. adjusting the CDS Asset chosen according to the system's findings by
i. making design changes to the CDS Asset and/or measures chosen, repeat step a
ii. redeploy the redesigned CDS Asset
iii. reevaluate the CDS Asset, Repeat step b, and c
iv. reiterate as required

4. The method of claim 3 where added to step b(iv) is the following limitation:
Where all the patient records can be semantically indexed to accelerate future retrieval semantically indexing the CIS's native data for each deployable CDS Asset being measured which is used or relevant to be used for the patient conditions handled by the CDS Asset in the CIS AND apply direct semantic query to the CIS's native patient data

5. An automated system for creation and real-time deployment of Clinical Decision Support (CDS) Assets into dynamic a clinical information system (CIS) and for assessing the impact of changes to certain of the CDS Assets in terms of cost and clinical performance measures by reference to information in the CIS, to provide evidence-based CDS Asset adjustments for improved Evidence Based Medicine (EBM) and care provided by one or more computing devices operatively interconnected to a CIS with conventional other input/output, storage, processing and memory means, programmed and configured with various operational means to provide each function step set out below, said means comprising means for:
a. building a deployable CDS asset (which CDS Asset may be comprised of an order set, clinical documentation template, rule, assessment model, care pathway, care plan or similar documentation or intervention protocol);
i. importing basic natural concepts of a CDS Asset including orders, observations, or qualifying concepts from a common electronic format, including word, text, spreadsheet, XML, or data extract from a CIS
ii. translating the CDS Asset and the basic CDS natural concepts into native coded concepts (which concepts may comprise observations, orders, and qualifying dictionaries, etc.) of the CIS and specifications of their native deployable structure
iii. translating the same native coded concepts to standard semantic ontology concepts (which ontology concepts may be from SNOMED CT, RxNORM, RadLex, LOINC, CPT, UMLS or similar standard semantic ontologies)
iv. structuring the translated CDS asset and concepts into one or more appropriate CDS Asset model schemas such as order sets, clinical documentation templates, assessment models, rules, measures, and other clinical support tools with observations and interventions
v. presenting the CDS Assets for formal or informal review which may include one or more of:
i. presenting design in a simulation of clinical workflow;
ii. presenting a potentially realistic CIS simulation;
iii. manual validation and refinement of concepts; or
iv. approval of the CDS Asset for deployment
vi. assembling and scheduling a release bundle of proposed/improved CDS Assets
vii. deploying the improved/proposed CDS Asset into the CIS, with or without version control or other standard operational protocols to:
i. establish a point-in-time record of deployment of the CDS Assets and components into target CIS;
ii. capture a record of the CDS Asset version being reviewed, review feedback, and approval;
b. building (at least one) performance measure for clinical effectiveness assessment including determining the presence or lack of presence in the patient record of documented symptoms, conditions, history, interventions ordered and performed, qualifying intervention details specific to the patient, and any other data that may be associated with a patient in a CIS, including the steps of:
i. translating the natural measure concepts to standard terminologies and/or semantic ontology concepts
ii. identifying the scope of clinical context of the deployable CDS Assets that are involved in the measurement via semantic similarity, directly linked CDS Assets, and overarching CDS Asset types which may include care pathways, or care plans, or other CDS type that coordinate aspects of care and other CDS Assets in support of those aspects of care
iii. looking up a native deployment configuration of the CIS Asset data schema specification to define how to retrieve patient data relevant to the CDS Asset being measured
iv. dynamically assembling a native query to retrieve the clinical context of the patient record relevant to the measure;
v. from the retrieved semantic data of the clinical context relevant to the measure, concluding whether the measure was satisfied, or not satisfied, i.e. present or not present, or evaluating and recording a measure expression to infer a result value
vi. assembling one or more measures into profiles to measure segments of one or more CDS Assets to achieve multiple levels of evaluation based upon elements of the CIS′ patient data, including:
L1. is the patient a candidate for this effectiveness assessment—right patient conditions, disorders, criteria, age, gender, etc.
L2. was the appropriate care plan/treatment used for the disorder and indications
L3. was the appropriate care plan/treatment applied by the care team, were all the orders delivered
L4. if (one or more of L1-L3 is) yes, then is the CDS Asset's intervention/treatment working or not (i.e. is the utilization change, cost change, outcome change as expected, positive or negative?)
L5. what changes to the CDS Asset being measured yielded the greatest impact and in what measured dimension/profile segment?
c. evaluating the measures by:
i. using the CDS Asset's semantic context and deployment configuration specification, to assemble a clinical context for querying, and retrieving data that is in scope of the measurement profile
ii. aggregating measure inferred result data into one or more useful reports showing baseline CDS Asset performance
iii. if measuring a modified CDS Asset that has been updated and deployed, then calculating and reporting on comparison of CDS Asset performance before CDS Asset change deployed vs after CDS Asset change deployed to identify an impact of the change
iv. identifying CDS Asset changes with the greatest impact, by making a report ranking greatest change
d. adjusting the CDS Asset chosen according to the system's findings by
i. making design changes to the CDS Asset and/or measures chosen, repeat step a
ii. redeploy the redesigned CDS Asset
iii. reevaluate the CDS Asset, Repeat step b, and c
iv. reiterate as required
